(19) United States
(12) Patent Application Publication
(10) Pub. No.: US 2006/0184962 A1
(43) Pub. Date: Aug. 17, 2006

(54) Methods for controlling apparatuses having an emergency alert function

(76) Inventors: Scott Allan Kendall, Westfield, IN (US); John Douglas Merrell, Noblesville, IN (US); Roger Lee Lineberry, Avon, IN (US); Timothy Joseph Tully, Noblesville, IN (US); Bruce Wayne Schaffer, Carmel, IN (US); Gavin Lee Johnston, Indianapolis, IN (US); Rajeev Madhukar Sahasrabudhe, Fishers, IN (US)

Correspondence Address: THOMSON LICENSING INC., PATENT OPERATIONS, PO BOX 5312, PRINCETON, NJ, 08543-5312, US

(21) Appl. No.: 10/551,086

(22) PCT Filed: Mar. 30, 2004
(86) PCT No.: PCT/US04/09712

§ 371 Date: Sep. 27, 2005

Related U.S. Application Data
(60) Provisional application No. 60/458,984, filed on Mar. 31, 2003.

(51) Int. Cl. H04N 7/10; H04N 7/025; H04N 7/173

(52) U.S. Cl. 725/33; 725/100

(57) ABSTRACT

An apparatus such as a television signal receiver, radio or other device provides an emergency alert function. According to an exemplary embodiment, the apparatus includes a processor operative to detect a first condition wherein signal strength on a selected channel frequency associated with the emergency alert function exceeds a predetermined threshold, and to detect a second condition wherein a broadcast test associated with said emergency alert function is passed. A visual indicator is operative to provide a predetermined output if the first and second conditions are detected.

This application claims the benefit, under 35 U.S.C. § 365 of International Application PCT/US04/009712, filed Mar. 30, 2004, which was published in accordance with PCT Article 21(2) on Oct. 28, 2004 in English and which claims the benefit of U.S. provisional patent application No. 60/458,984, filed Mar. 31, 2003.

The present invention generally relates to apparatuses such as television signal receivers, radios or other apparatuses having an emergency alert function, and more particularly, to various techniques for controlling such apparatuses which improve the overall performance of the emergency alert function.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain apparatuses are capable of receiving emergency alert signals provided by sources such as the NWS and NOAA, and provide an emergency alert function using Specific Area Message Encoding (SAME) technology. Apparatuses using SAME technology typically require a user to perform a setup process for the emergency alert function by selecting items such as a channel frequency which is monitored in order to receive emergency alert signals, one or more geographical areas of interest, and one or more types of emergency events which activate the emergency alert function. Once the setup process is complete, the emergency alert function may be activated when incoming emergency alert signals including SAME data indicate the occurrence of an emergency event which corresponds to the geographical area(s) and types of emergency event selected by the user during the setup process. When the emergency alert function is activated, one or more alert outputs such as an audio and/or visual message may be provided to alert individuals of the emergency event.

With apparatuses using technology such as SAME technology, the aforementioned setup process can be confusing for users. In particular, the selection of a channel frequency for receiving emergency alert signals can be especially problematic. For example, certain apparatuses allow a user to manually select one of 7 different NWS channel frequencies. In general, a user will attempt to select the channel frequency that provides the highest signal strength. However, the task of selecting the channel frequency that provides the highest signal strength may introduce the possibility of error since the user is required to discriminate among multiple low-wattage signal strength transmissions. Moreover, a selected channel frequency may not provide all of the information that a user desires. For example, if a user wants to receive alert information for a geographical area which is not covered by the selected channel frequency, then the user will not receive the desired alert information.

Certain apparatuses may use a processing procedure wherein the apparatus interprets test signals. If a test signal is not received, the apparatus may display a warning message (e.g., “Check OP”) for the user. However, this approach is problematic since the causes for the warning message are varied, and may require considerable unaided diagnosis on the part of the user.

Other apparatuses may ask a user for his or her geographical location. Such apparatuses may include memory for storing information regarding all of the transmitters serving all geographical areas. Once the user indicates his or her geographical location, the apparatus uses the stored transmitter information to select the channel frequency that serves the user's area. This approach works well as long as the stored transmitter information is current and up-to-date. However, NOAA is rapidly adding new transmitters, and may also change the channel frequencies used by certain existing transmitters. Since such apparatuses may have no means by which to update their information, they may not select the best channel frequency. Such apparatuses may also allow users to select geographical areas for which alert information may not be provided by the selected channel frequency. This may give users a false belief that they will receive alert information for certain geographical areas.

The present invention described herein provides various techniques for controlling apparatuses having an emergency alert function which address the foregoing and/or other issues.

In accordance with an aspect of the present invention, a method for controlling an apparatus having an emergency alert function is disclosed. According to an exemplary embodiment, the method comprises steps of detecting a first condition wherein signal strength on a selected channel frequency associated with the emergency alert function exceeds a predetermined threshold, detecting a second condition wherein a broadcast test associated with the emergency alert function is passed, and providing a predetermined output if the first and second conditions are detected.

In accordance with another aspect of the present invention, an apparatus having an emergency alert function is disclosed. According to an exemplary embodiment, the apparatus comprises processing means for detecting a first condition wherein signal strength on a selected channel frequency associated with the emergency alert function exceeds a predetermined threshold, and for detecting a second condition wherein a broadcast test associated with the emergency alert function is passed. First output means provide a predetermined output if the first and second conditions are detected.

In accordance with yet another aspect of the present invention, a television signal receiver having an emergency alert function is disclosed. According to an exemplary embodiment, the television signal receiver comprises a processor operative to detect a first condition wherein signal strength on a selected channel frequency associated with the emergency alert function exceeds a predetermined threshold, and to detect a second condition wherein a broadcast test associated with the emergency alert function is passed. A visual indicator is operative to provide a predetermined output if the first and second conditions are detected.

The above-mentioned and other features and advantages of this invention, and the manner of attaining them, will become more apparent and the invention will be better understood by reference to the following description of embodiments of the invention taken in conjunction with the accompanying drawings, wherein:

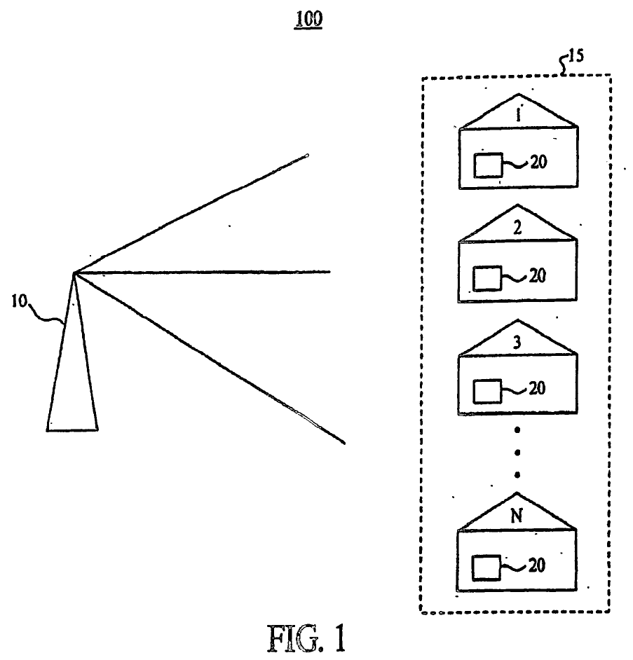

FIG. 1 is an exemplary environment suitable for implementing the present invention;

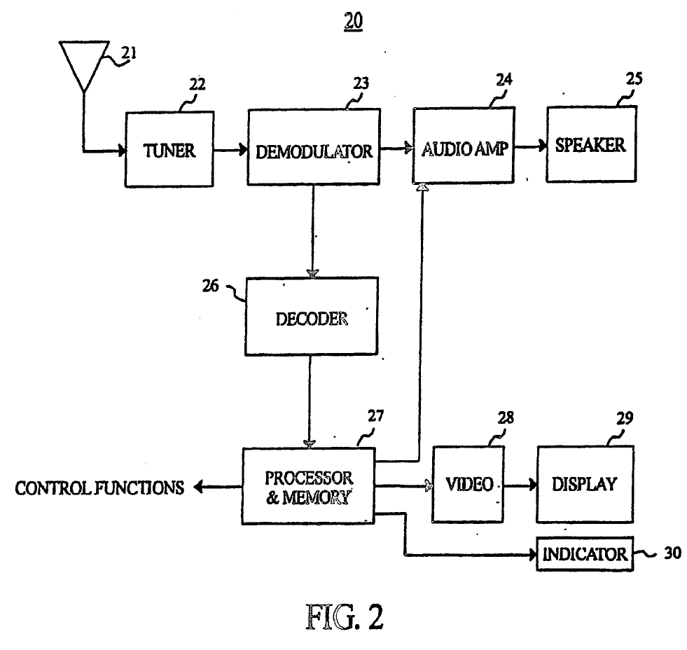

FIG. 2 is a block diagram of a television signal receiver according to an exemplary embodiment of the present invention;

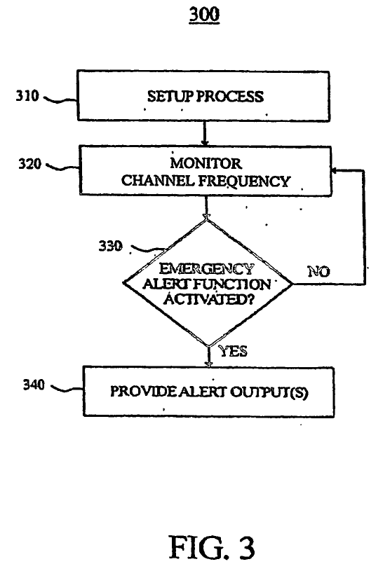

FIG. 3 is a flowchart illustrating exemplary steps according to one aspect of the present invention;

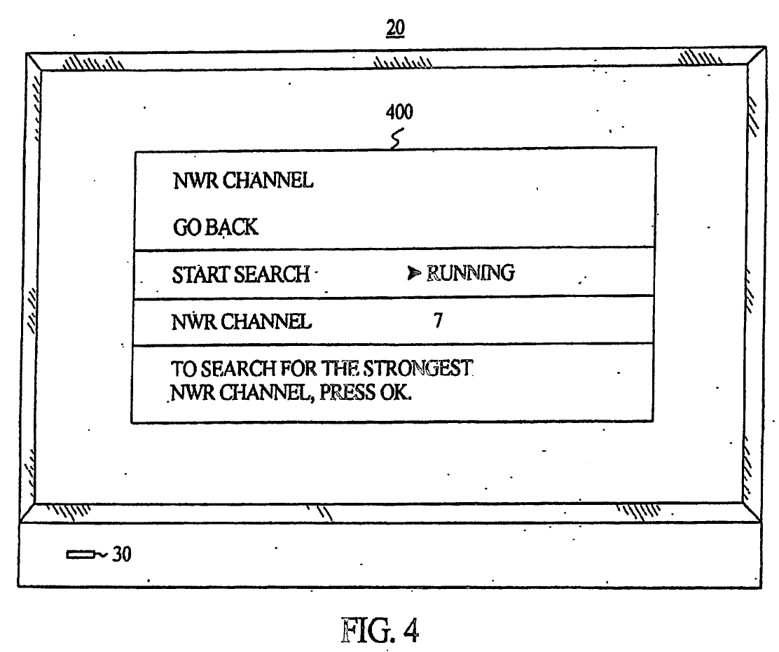

FIG. 4 is an exemplary display suitable for use when practicing the aspect of the present invention represented in FIG. 3;

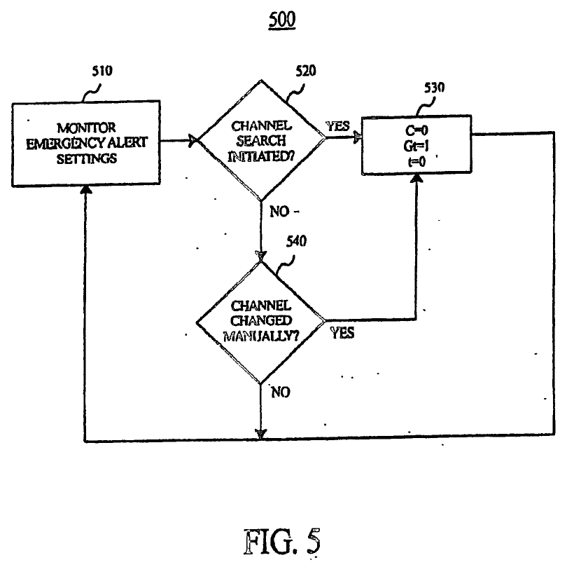

FIG. 5 is a flowchart illustrating exemplary steps according to another aspect of the present invention;

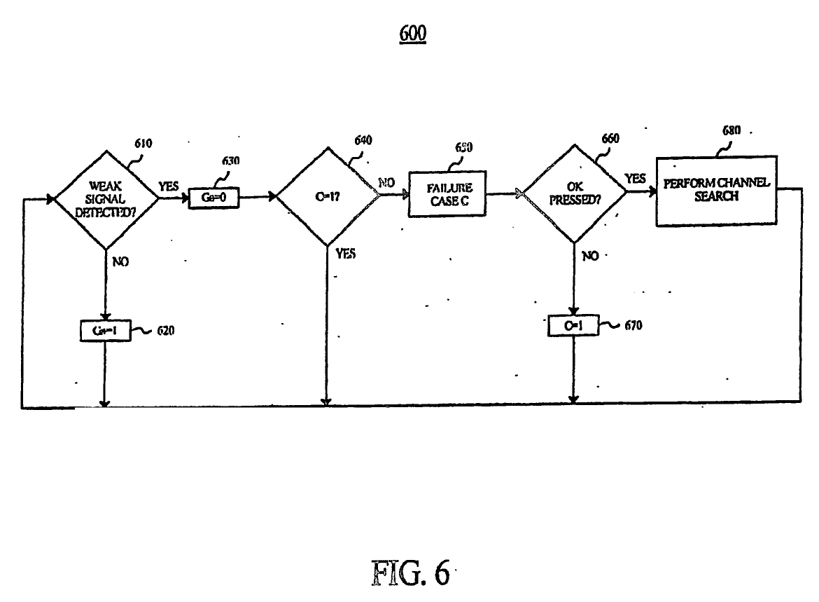

FIG. 6 a flowchart illustrating exemplary steps according to still another aspect of the present invention;

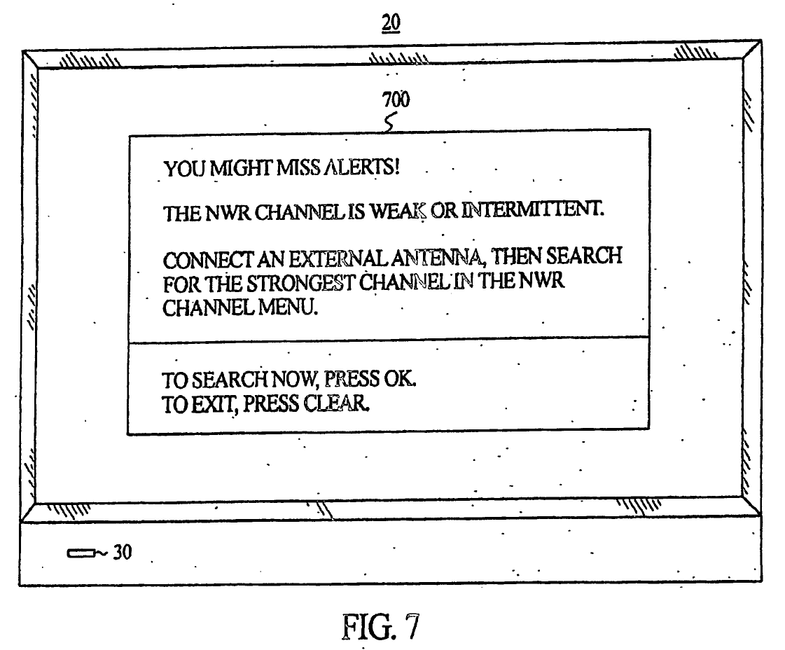

FIG. 7 is an exemplary display suitable for use when practicing the aspect of the present invention represented in FIG. 6;

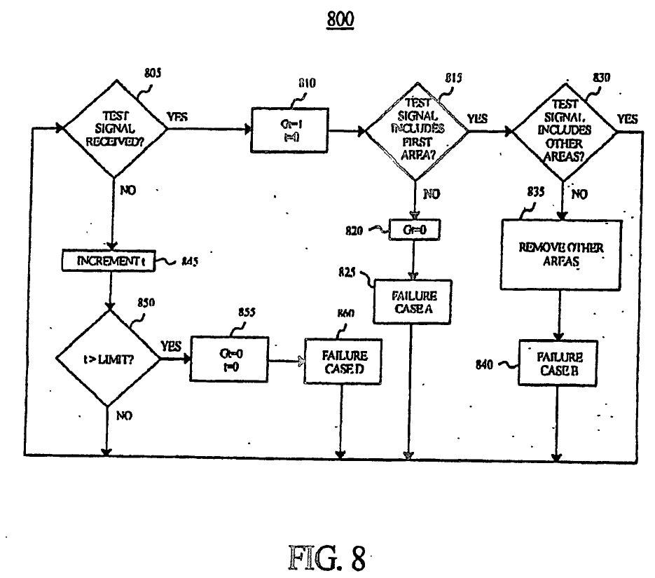

FIG. 8 is a flowchart illustrating exemplary steps according to yet another aspect of the present invention;

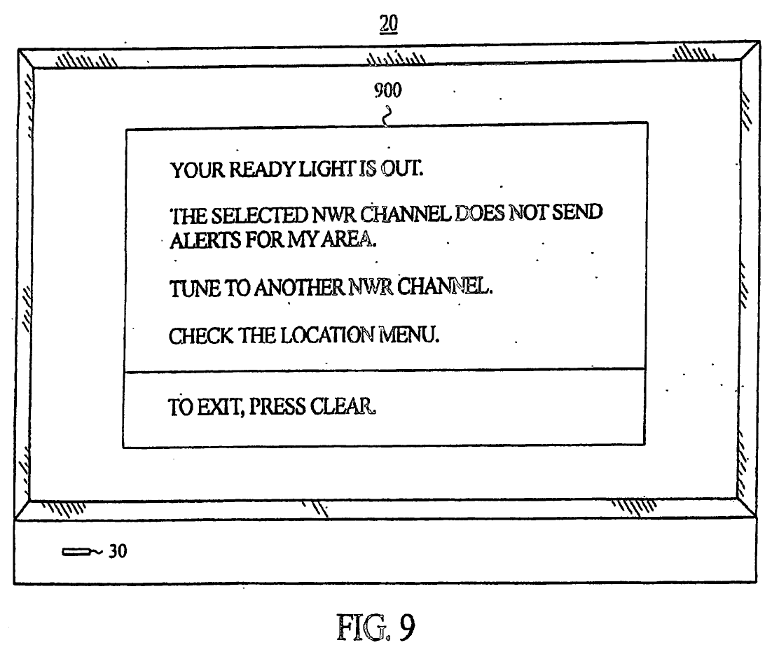

FIGS. 9 to 11 are exemplary displays suitable for use when practicing the aspect of the present invention represented in FIG. 8; and

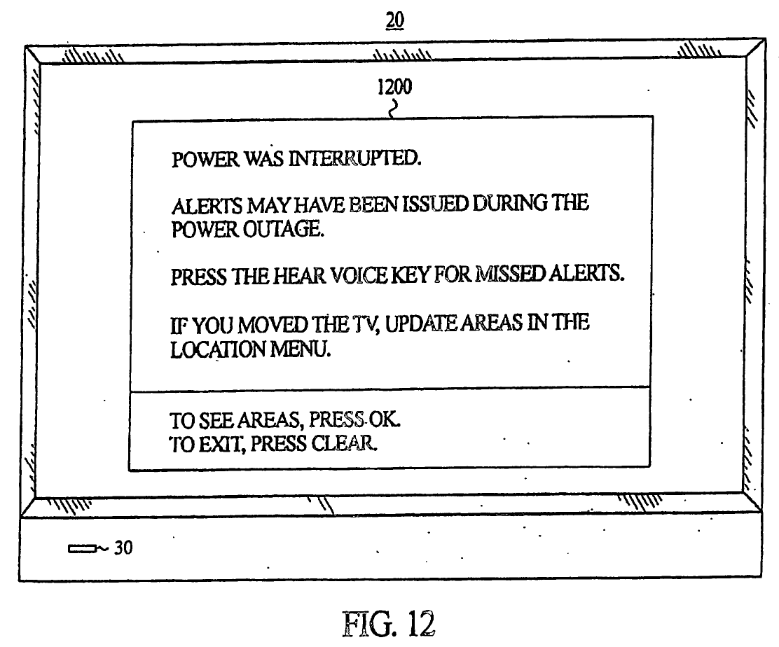

FIG. 12 is an exemplary display suitable for use when power to the television signal receiver of FIG. 2 is interrupted.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as television signal receivers 20.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables, among other things, television signal receiver 20 to receive emergency alert signals and provide one or more alert outputs to notify individuals of an emergency event. For purposes of example, the present invention will be described herein with reference to television signal receiver 20. However, the principles of the present invention may also be used by other apparatuses, such as radios.

According to an exemplary embodiment, signal transmission source 10 broadcasts signals including audio, video and/or emergency alert signals which may be received by each television signal receiver 20. According to an exemplary embodiment, the emergency alert signals may be provided from an authority such as the NWS, or other authorities such as governmental entities or the like. Signal transmission source 10 may broadcast the emergency alert signals in their original form as provided by the authority, or may append digital data representative of the emergency alert signals to other data, or may modify the emergency alert signals in some manner appropriate for its specific transmission format needs. In response to the emergency alert signals, each television signal receiver 20 may provide one or more alert outputs to thereby notify individuals of the emergency event. Signal transmission source 10 may broadcast signals to television signal receivers 20 via any wired or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29 and indicator 30. Some of the foregoing elements may for example be embodied using integrated circuits (ICs). For clarity of description, conventional elements of television signal receiver 20 such as certain control signals, power signals, and/or other elements may not be shown in FIG. 2.

Signal receiving element 21 is operative to receive signals including audio, video and/or emergency alert signals from signal sources, such as signal transmission source 10 in FIG. 1. According to an exemplary embodiment, received audio signals may include digitally encoded emergency alert signals. According to another exemplary embodiment, emergency alert signals may be received as separate data packets in a digital transmission system. Signal receiving element 21 may be embodied as any signal receiving element such as an antenna, input terminal or other element.

Tuner 22 is operative to tune signals including audio, video and/or emergency alert signals. According to an exemplary embodiment, tuner 22 may be capable of tuning audio signals on at least the following designated NWS frequencies: 162.400 MHz, 162.425 MHz, 162.450 MHz, 162.475 MHz, 162.500 MHz, 162.525 MHz and 162.550 MHz. As previously indicated herein, such audio signals may include digitally encoded emergency alert signals. Tuner 22 may also tune other channel frequencies including those used in terrestrial, cable, satellite and/or other transmissions.

Demodulator 23 is operative to demodulate signals provided from tuner 22, and may demodulate signals in analog and/or digital transmission formats. According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to one or more control signals provided from processor 27. Speaker 25 is operative to aurally output the amplified audio signals provided from audio amplifier 24.

Decoder 26 is operative to decode signals including audio, video and/or emergency alert signals. According to an exemplary embodiment, decoder 26 decodes audio signals to thereby extract digitally encoded frequency shift keyed (FSK) signals, which represent emergency alert signals indicating an emergency event. According to another exemplary embodiment, decoder 26 decodes digital data which represents emergency alert signals indicating an emergency event. Decoder 26 may also perform other decoding functions, such as decoding data which represents emergency alert signals included in the vertical blanking interval (VBI) of an analog television signal.

According to an exemplary embodiment, the emergency alert signals include data comprising SAME data associated with the emergency event. SAME data comprises a digital code representing information such as the specific geographical area affected by the emergency event, the type of emergency event (e.g., tornado watch, radiological hazard warning, civil emergency, etc.), and the duration of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of television signal receiver 20 allows a user to select items such as an applicable geographical area(s), and type(s) of emergency events (e.g., tornado watch, radiological hazard warning, civil emergency, etc.) which activate the emergency alert function.

When the emergency alert function of television signal receiver 20 is activated, processor 27 outputs one or more control signals which enable various operations. According to an exemplary embodiment, such control signals enable one or more alert outputs (e.g., aural and/or visual) to thereby notify individuals of the emergency event. Such control signals may also enable other operations of television signal receiver 20, such as causing it to be switched from an off/standby mode to an on mode.

Processor 27 is also operative to perform various other operations associated with the emergency alert function of television signal receiver 20. According to an exemplary embodiment, processor 27 enables an auto-tune mode which provides a convenient means by which users can select a channel frequency for receiving emergency alert signals. To enable the auto-tune mode, processor 27 outputs one or more control signals which cause tuner 22 to scan a plurality of channel frequencies associated with the emergency alert function. In this manner, processor 27 may identify one or more channel frequencies associated with the emergency alert function which provides the highest signal strength.

Processor 27 is also operative to detect various conditions relating to the emergency alert function. According to an exemplary embodiment, processor 27 is operative to detect: (1) a first condition wherein signal strength on a selected channel frequency associated with the emergency alert function exceeds a predetermined threshold, and (2) a second condition wherein a broadcast test associated with the emergency alert function is passed. According to this exemplary embodiment, processor 27 sets an internal flag Ga equal to one if the first condition is detected, and sets another internal flag Gt equal to one if the second condition is detected. Processor 27 is also operative to detect any user inputs which affect the emergency alert function or its settings. Further details regarding the aforementioned aspects of the present invention will be provided later herein.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays. Display 29 is operative to provide visual displays corresponding to processed signals provided from video processor 28. According to an exemplary embodiment, display 29 may provide visual displays including the aforementioned messages that provide details regarding emergency events.

Indicator 30 is operative to provide predetermined visual outputs indicating the operating state of the emergency alert function. Indicator 30 may be embodied as a light emitting diode (LED) and/or other element, and may for example be located on a front panel or other readily viewable area of television signal receiver 20. According to an exemplary embodiment, indicator 30 is illuminated (e.g., in green or other color) responsive to a control signal from processor 27 if the first and second conditions associated with the emergency alert function described above are detected (i.e., if flags Ga and Gt are both equal to one). In this manner, indicator 30 provides a visual output for users to indicate that the emergency alert function is in a “ready” (i.e., operative) state.

Referring now to FIG. 3, a flowchart 300 illustrating exemplary steps according to one aspect of the present invention is shown. In particular, FIG. 3 illustrates the general operation of the emergency alert function according to an exemplary embodiment of the present invention. For purposes of example and explanation, the steps of FIG. 3 will be described with reference to television signal receiver 20 of FIG. 2. The steps of FIG. 3 are merely exemplary, and are not intended to limit the present invention in any manner.

At step 310, a setup process for the emergency alert function of television signal receiver 20 is performed. According to an exemplary embodiment, a user performs this setup process by providing inputs to television signal receiver 20 (e.g., using a remote control device not shown) responsive to an on-screen menu displayed via display 29. Such an on-screen menu may for example be part of an electronic program guide (EPG) function of television signal receiver 20. According to an exemplary embodiment, the user may select at least the following items during the setup process at step 310:
A. Enable/Disable—The user may select whether to enable or disable the emergency alert function.
B. Channel frequency—The user may select the channel frequency which is monitored in order to receive emergency alert signals. For example, the user may select a frequency such as one of the following NWS transmission frequencies: 162.400 MHz, 162.425 MHz, 162.450 MHz, 162.475 MHz, 162.500 MHz, 162.525 MHz and 162.550 MHz. According to an exemplary embodiment, a channel frequency may be manually selected by the user, or may be selected using an auto-tune mode which automatically tunes all of the channel frequencies associated with the emergency alert function to thereby identify one or more channel frequencies that provide the highest signal strength. If multiple channels having equally strong signal strength are identified, the lowest numbered channel may for example be selected. If no channel frequency having requisite signal strength to allow proper decoding of SAME data is detected during the auto-tune mode, the currently established channel frequency may be selected by default. According to an exemplary embodiment, the selection of a channel frequency may be facilitated by an on-screen display such as on-screen display 400 shown in FIG. 4.
C. Geographical Areas—The user may select one or more geographical areas of interest. For example, the user may select a particular continent, country, region, state, area code, zip code, city, county, municipality, subdivision, and/or other definable geographical area. As will be discussed later herein, such geographical area(s) may be represented by location codes, such as Federal Information Processing Standard (FIPS) location codes.
D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., advisory, watch, warning, etc.) may represent different “events.” For example, a thunderstorm watch may be considered a different event from a thunderstorm warning.
E. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune television signal receiver 20 to a specific channel. The user may also for example select to aurally output a warning tone (e.g., chime, siren, etc.) and/or an audio message (e.g., NWS audio message), and the desired volume of each. Moreover, the alert outputs may be selected on an event-by-event basis. Other types of alert outputs may also be provided according to the present invention.

According to the present invention, other menu selections may also be provided at step 310 and/or some of the menu selections described above may be omitted. Data corresponding to the user's selections during the setup process of step 310 is stored in memory 27.

At step 320, television signal receiver 20 monitors the frequency selected by the user during the setup process of step 310 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content.

At step 330, a determination is made as to whether the emergency alert function of television signal receiver 20 is activated. According to an exemplary embodiment, processor 27 makes this determination by comparing data included in the incoming emergency alert signals to data stored in memory 27. As previously indicated herein, the emergency alert signals may include data such as SAME data which represents information including the type of emergency event (e.g., tornado watch, radiological hazard warning, civil emergency, etc.) and the specific geographical area(s) affected by the emergency event. According to an exemplary embodiment, processor 27 compares this SAME data to corresponding user setup data (i.e., items C and D of step 310) stored in memory 27 to thereby determine whether the emergency alert function is activated. In this manner, the emergency alert function of television signal receiver 20 is activated when the emergency event indicated by the emergency alert signals corresponds to: (1) the geographical area(s) selected by the user for item C of step 310 and (2) the event type(s) selected by the user for item D of step 310.

If the determination at step 330 is negative, process flow loops back to step 320 where tuner 22 continues to monitor the selected channel frequency. Alternatively, if the determination at step 330 is positive, process flow advances to step 340 where television signal receiver 20 provides one or more alert outputs to thereby notify individuals of the emergency event.

According to an exemplary embodiment, processor 27 enables the one or more alert outputs at step 340 in accordance with the user's selections during the setup process of step 310 (i.e., item E), and such alert outputs may be aural and/or visual in nature. For example, aural outputs such as a warning tone and/or an NWS audio message may be provided at step 340 via speaker 25, and the volume of such aural outputs may be controlled in accordance with the volume level set by the user during the setup process of step 310. Visual outputs may also be provided at step 340 via display 29 to notify individuals of the emergency event. According to an exemplary embodiment, an auxiliary information display such as an NWS text message (e.g., as a closed caption display) and/or a video output from a specific channel may be provided at step 340 via display 29 under the control of processor 27.

According to another exemplary embodiment, the alert output(s) provided at step 340 may be based on the severity or alert level of the particular emergency event. For example, emergency events may be classified in one of three different alert level categories, such as statement, watch, and warning. With such a classification scheme, the alert output for an emergency event at a level 1 or statement level may be provided by an unobtrusive notification means such as a blinking LED since it is the least severe type of emergency event. The alert output for an emergency event at a level 2 or watch level may have some type of audio component (e.g., radio message). The alert output for an emergency event at a level 3 or warning level may be provided by a siren or other type of alarm since it is the most severe type of emergency event. Other types of aural and/or visual alert outputs than those expressly described herein may also be provided at step 340 according to the present invention.

Referring now to FIG. 5, a flowchart 500 illustrating exemplary steps according to another aspect of the present invention is shown. In particular, FIG. 5 relates to an aspect of the present invention in which certain internal flags of processor 27 are set responsive to detecting a user action to set the channel frequency for receiving emergency alert signals (i.e., item B of step 310). For purposes of example and explanation, the steps of FIG. 5 will also be described with reference to television signal receiver 20 of FIG. 2. The steps of FIG. 5 are merely exemplary, and are not intended to limit the present invention in any manner.

At step 510, processor 27 monitors the emergency alert settings established at step 310 of FIG. 3 for any inputs by a user. At step 520, processor 27 determines whether a channel search is initiated. According to an exemplary embodiment, a channel search may be initiated through the previously described auto-tune mode which causes television signal receiver 20 to automatically tune all of the channel frequencies associated with the emergency alert function to thereby identify one or more channel frequencies that provide the highest signal strength.

If the determination at step 520 is positive, process flow advances to step 530 where processor 27 sets a flag C equal to zero, sets flag Gt equal to one, and also sets a variable t equal to zero. As will be described later herein, flag C relates to a Case C failure of the emergency alert function, and variable t is a time variable. As previously indicated herein, flag Gt relates to a broadcast test associated with the emergency alert function. From step 530, process flow loops back to step 510 where the emergency alert settings of television signal receiver 20 continue to be monitored for any inputs by a user. Alternatively, if the determination at step 520 is negative, process flow advances to step 540 where processor 27 determines whether the currently set channel frequency is manually changed by a user. If the determination at step 540 is positive, process flow advances to step 530 where processor 27 sets flag C equal to zero, sets flag Gt equal to one, and also sets variable t equal to zero. From step 530, process flow loops back to step 510. If the determination at step 540 is negative, process flow simply loops back to step 510.

Referring to FIG. 6, a flowchart 600 illustrating exemplary steps according to still another aspect of the present invention is shown. In particular, FIG. 6 relates to an aspect of the present invention that monitors the signal strength on the selected channel frequency for receiving emergency alert signals, and informs users when signal strength problems occur. For purposes of example and explanation, the steps of FIG. 6 will also be described with reference to television signal receiver 20 of FIG. 2. The steps of FIG. 6 are merely exemplary, and are not intended to limit the present invention in any manner.

At step 610, processor 27 determines whether a weak signal on the channel frequency selected for receiving emergency alert signals is detected. According to an exemplary embodiment, the determination at step 610 is positive if the signal strength on the channel frequency selected for receiving emergency alert signals fails to exceed a predetermined threshold sufficient to enable proper decoding of SAME data for a predetermined time period (e.g., 2 seconds or more). In practice, both the predetermined threshold and the predetermined time period used at step 610 may be a matter of design choice. If the determination at step 610 is negative, process flow advances to step 620 where processor 27 sets a flag Ga equal to one. Accordingly, flag Ga equals one as long as the signal strength on the channel frequency selected for receiving emergency alert signals exceeds the predetermined threshold sufficient to enable proper decoding of SAME data. According to an exemplary embodiment, indicator 30 is illuminated to indicate a “ready” (i.e., operative) state of the emergency alert function only if flags Ga and Gt both equal one. From step 620, process flow loops back to step 610.

Alternatively, if the determination at step 610 is positive, process flow advances to step 630 where processor 27 sets flag Ga equal to zero. Next, at step 640, processor 27 determines whether flag C is equal to one. If the determination at step 640 is positive, process flow loops back to step 610. Alternatively, if the determination at step 640 is negative, process flow advances to step 650 where processor 27 determines that a Case C failure exists. According to an exemplary embodiment, a Case C failure exists when the signal strength on the channel frequency selected for receiving emergency alert signals fails to exceed the predetermined threshold for a predetermined time period.

When a Case C failure exists at step 650, processor 27 outputs one or more control signals to enable an output message for the user. FIG. 7 shows an example of an output message 700 which may be displayed via display 29 in the event of a Case C failure at step 650. As shown in FIG. 7, exemplary output message 700 indicates one or more corrective actions to be taken by the user, such as connecting an external antenna to television signal receiver 20 to improve signal reception, and/or performing a channel search using the auto-tune mode to identify the channel frequency for receiving emergency alert signals having the highest signal strength.

At step 660, processor 27 determines whether a user has pressed an OK key (e.g., on a remote control device) responsive to the Case C failure at step 650. If the determination at step 660 is negative, process flow advances to step 670 where processor 27 sets flag C equal to one. From step 670, process flow loops back to step 610. Alternatively, if the determination at step 660 is positive, process flow advances to step 680 where a channel search is performed using the auto-tune mode to thereby identify the channel frequency for receiving emergency alert signals having the highest signal strength. The identified channel frequency having the highest signal strength may then be monitored for emergency alert signals. From step 680, process flow loops back to step 610.

Referring to FIG. 8, a flowchart 800 illustrating exemplary steps according to yet another aspect of the present invention is shown. In particular, FIG. 8 relates to a broadcast test associated with the emergency alert function. As part of this broadcast test, the present invention determines whether a predetermined broadcast test signal is received in a timely manner, and if so received, whether this test signal includes data corresponding to the geographical area(s) selected by the user (i.e., item C of step 310). Users are also informed regarding causes and corrective actions for problems associated with this broadcast test. For purposes of example and explanation, the steps of FIG. 8 will also be described with reference to television signal receiver 20 of FIG. 2. The steps of FIG. 8 are merely exemplary, and are not intended to limit the present invention in any manner.

At step 805, processor 27 determines whether the predetermined broadcast test signal is received. According to an exemplary embodiment, the test signal of step 805 may be part of a required weekly test (RWT) which broadcasts SAME data on a weekly basis with a list of all of the location codes (e.g. FIPS codes) that a particular transmitter serves. If the determination at step 805 is positive, process flow advances to step 810 where processor 27 sets flag Gt equal to one, and also sets variable t equal to zero. As previously indicated herein, indicator 30 is illuminated to indicate a “ready” (i.e., operative) state of the emergency alert function only if flags Ga and Gt both equal one.

At step 815, processor 27 determines whether the received test signal includes data corresponding to a first geographical area selected for item C of step 310. According to an exemplary embodiment, this first geographical area may represent the geographical area where television signal receiver 20 is physically located. If the determination at step 815 is negative, process flow advances to step 820 where processor 27 sets flag Gt equal to zero. Next, at step 825, processor 27 determines that a Case A failure exists. According to an exemplary embodiment, a Case A failure exists when the received test signal does not include data corresponding to a first geographical area selected for item C of step 310.

When a Case A failure exists at step 825, processor 27 outputs one or more control signals to enable an output message for the user. FIG. 9 shows an example of an output message 900 which may be displayed via display 29 in the event of a Case A failure at step 825. As indicated in FIG. 9, exemplary output message 900 informs users that indicator 30 (i.e., the “ready” light) is not illuminated, and that the currently selected channel frequency for receiving emergency alert signals does not provide alert information for the first geographical area (i.e., my area). Output message 900 also indicates one or more corrective actions to be taken by the user, such as tuning television signal receiver 20 to another channel frequency for receiving emergency alert signals. From step 825, process flow loops back to step 805.

Referring back to step 815, if the determination is positive, process flow advances to step 830 where processor 27 determines whether the received test signal includes data corresponding to one or more other geographical areas selected for item C of step 310. According to an exemplary embodiment, these other geographical areas may represent areas that are nearby the first geographical area. If the determination at step 830 is negative, process flow advances to step 835 where processor 27 removes the one or more other geographical areas from the user setup data stored in memory 27. Next, at step 840, processor 27 determines that a Case B failure exists. According to an exemplary embodiment, a Case B failure exists when the received test signal includes data corresponding to the first geographical area, but does not include data corresponding to the one or more other geographical areas selected for item C of step 310.

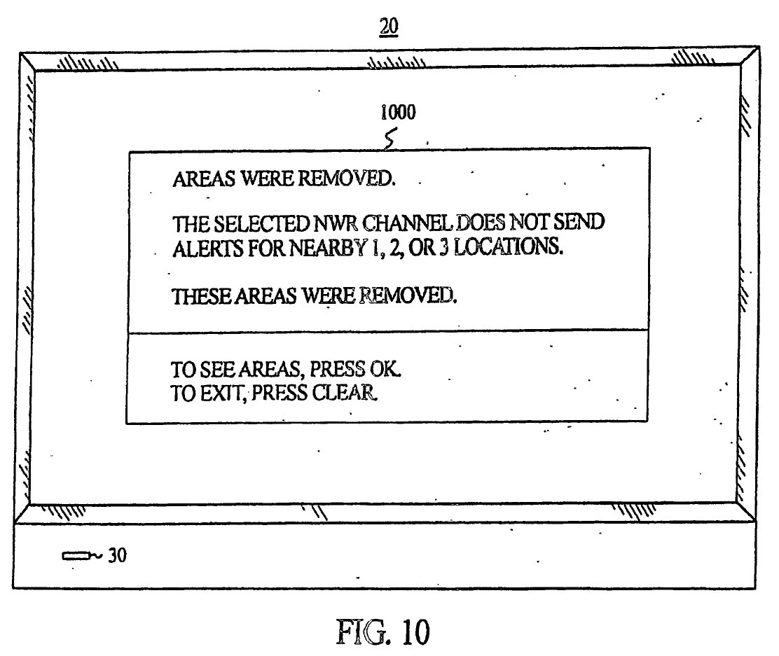

When a Case B failure exists at step 840, processor 27 outputs one or more control signals to enable an output message for the user. FIG. 10 shows an example of an output message 1000 which may be displayed via display 29 in the event of a Case B failure at step 840. As indicated in FIG. 10, exemplary output message 1000 informs users that the currently selected channel frequency for receiving emergency alert signals does not provide alert information for the one or more other geographical areas (i.e., nearby 1, 2, or 3 locations), and that these areas have been removed from the user setup data stored in memory 27. Output message 1000 also enables a user to see the remaining geographical areas by pressing a predetermined key (e.g., OK key on remote control device). From step 840, process flow loops back to step 805.

Referring back to step 805, if the determination is negative, process flow advances to step 845 where processor 27 increments variable t by one. Next, at step 850, processor 27 determines whether the value of variable t is greater than its predetermined limit. According to an exemplary embodiment, the predetermined limit for variable t may be selected to correspond to a time period that is equal to one week, or slightly more than one week. For example, variable t may be selected to correspond to a time period that is equal to 9¼ days, or 222 hours. Other time periods may also be used. If the determination at step 850 is negative, process flow loops back to step 805. Alternatively, if the determination at step 850 is positive, process flow advances to step 855 where processor 27 sets flag Gt equal to zero, and also sets variable t equal to zero. Next, at step 860, processor 27 determines that a Case D failure exists. According to an exemplary embodiment, a Case D failure exists when the broadcast test signal is not received in a timely manner.

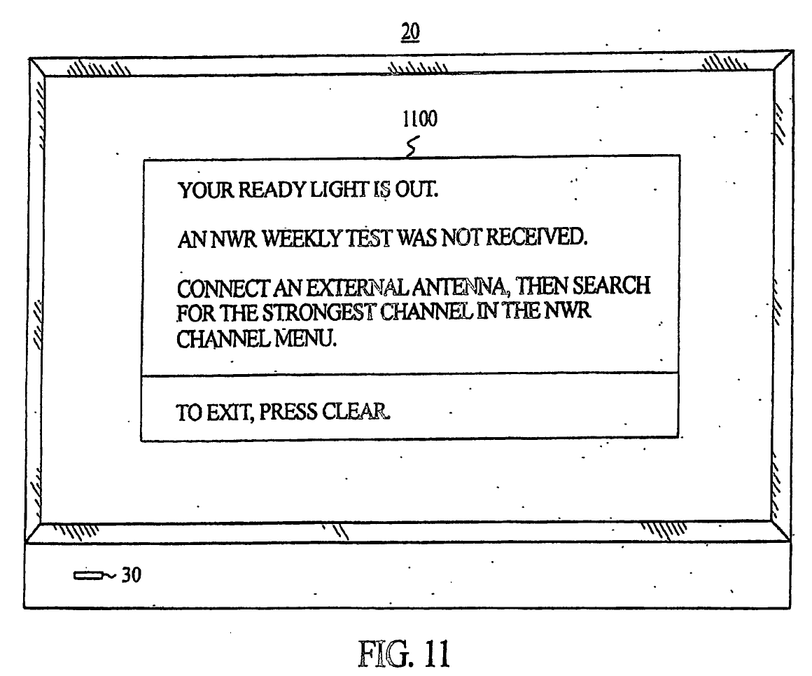

When a Case D failure exists at step 860, processor 27 outputs one or more control signals to enable an output message for the user. FIG. 11 shows an example of an output message 1100 which may be displayed via display 29 in the event of a Case D failure at step 860. As indicated in FIG. 11, exemplary output message 1100 informs users that indicator 30 (i.e., the “ready” light) is not illuminated, and that the broadcast test signal was not received. Output message 1100 also indicates one or more corrective actions to be taken by the user, such as connecting an external antenna to television signal receiver 20 to improve signal reception, and/or performing a channel search using the auto-tune mode to identify the channel frequency for receiving emergency alert signals having the highest signal strength. From step 860, process flow loops back to step 805.

It should also be appreciated that the principles of the present invention reflected herein may be combined in any suitable manner. For example, any of the aspects of the present invention represented in the flowcharts of FIGS. 3, 5, 6 and 8 may be combined according to design choice. Moreover, other types of output messages may also be provided according to the present invention to enhance the performance of the emergency alert function. For example, an output message such as exemplary output message 1200 of FIG. 12 may be displayed via display 29 to indicate that power to television signal receiver 20 has been interrupted. As indicated in FIG. 12, exemplary output message 1200 informs users of the power interruption and indicates one or more actions to be taken by the user related to the emergency alert function.

As described herein, the present invention provides various techniques for improving the performance of apparatuses having an emergency alert function. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for controlling an apparatus having an emergency alert function, comprising steps of:
detecting a first condition wherein signal strength on a selected channel associated with said emergency alert function exceeds a threshold;
detecting a second condition wherein a broadcast test associated with said emergency alert function is passed, said broadcast test including detecting reception of a test signal that is broadcast on a scheduled periodic basis; and
providing an output if said first and second conditions are detected.

2. The method of claim 1, wherein said broadcast test includes determining whether said test signal includes a user selected location code associated with said emergency alert function.

3. The method of claim 1, wherein said test signal is broadcast on a weekly basis.

4. The method of claim 1, further comprised of:
tuning a plurality of channels associated with said emergency alert function; and
identifying one of said channels having higher signal strength relative to said other channels as said selected channel.

5. The method of claim 4, further comprised of using said selected channel to receive emergency alert signals capable of activating said emergency alert function.

6. The method of claim 1, further comprised of:
providing a first output message if said first condition is not detected; and
providing a second output message if said second condition is not detected.

7. The method of claim 6, wherein said first and second output messages each indicates a corrective action.

8. An apparatus having an emergency alert function, comprising:
processing means for detecting a first condition wherein signal strength on a selected channel associated with said emergency alert function exceeds a threshold, and for detecting a second condition wherein a broadcast test associated with said emergency alert function is passed, said broadcast test including detecting reception of a test signal that is broadcast on a scheduled periodic basis; and
first output means for providing an output if said first and second conditions are detected.

9. The apparatus of claim 8, wherein said broadcast test includes determining whether said test signal includes a user selected location code associated with said emergency alert function.

10. The apparatus of claim 9, wherein said test signal is broadcast on a weekly basis.

11. The apparatus of claim 8, further comprising:
tuning means for tuning a plurality of channels associated with said emergency alert function; and
wherein one of said channels having higher signal strength relative to said other channels is identified as said selected channel.

12. The apparatus of claim 11, wherein said tuning means tunes said selected channel to receive emergency alert signals capable of activating said emergency alert function.

13. The apparatus of claim 8, further comprising second output means for providing a first output message if said first condition is not detected, and for providing a second output message if said second condition is not detected.

14. The apparatus of claim 13, wherein said first and second output messages each indicates a corrective action.

15. A television signal receiver having an emergency alert function, comprising:
a processor operative to detect a first condition wherein signal strength on a selected channel associated with said emergency alert function exceeds a threshold, and to detect a second condition wherein a broadcast test associated with said emergency alert function is passed, said broadcast test including detecting reception of a test signal that is broadcast on a scheduled periodic basis; and
a visual indicator operative to provide an output if said first and second conditions are detected.

16. The television signal receiver of claim 15, wherein said broadcast test includes determining whether said test signal includes a user selected location code associated with said emergency alert function.

17. The television signal receiver of claim 16, wherein said test signal is broadcast on a weekly basis.

18. The television signal receiver of claim 15, further comprising:
a tuner operative to tune a plurality of channels associated with said emergency alert function; and
wherein one of said channels having higher signal strength relative to said other channels is identified as said selected channel.

19. The television signal receiver of claim 18, wherein said tuner tunes said selected channel to receive emergency alert signals capable of activating said emergency alert function.

20. The television signal receiver of claim 15, further comprising a display operative to provide a first output message if said first condition is not detected, and a second output message if said second condition is not detected.

21. The television signal receiver of claim 20, wherein said first and second output messages each indicates a corrective action.
